(19) United States
(12) Patent Application Publication
(10) Pub. No.: US 2015/0181478 A1
(43) Pub. Date: Jun. 25, 2015

(54) INTER RADIO ACCESS TECHNOLOGY HANDOVER

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/139,712

(22) Filed: Dec. 23, 2013

(51) Int. Cl. H04W 36/00

(52) U.S. Cl. CPC H04W 36/0066; H04W 36/0072; H04W 88/06

(57) ABSTRACT

A user equipment (UE) combines baton and hard handover procedures to reduce handover latency, and improve throughput. In one instance, the UE receives a handover command and in response, substantially simultaneously initiates both a hard handover procedure and a baton handover procedure. When a hard handover response is received before a baton handover response, the UE continues with the hard handover procedure and then aborts the baton handover procedure. When the baton handover response is received before a hard handover response, the UE continues with the baton handover procedure and then aborts the hard handover procedure.

### TECHNICAL FIELD

Aspects of the present disclosure relate generally to wireless communication systems, and more particularly, to an improved inter radio access technology (IRAT) handover.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes receiving a handover command. The method also includes substantially simultaneously initiating both a hard handover procedure and a baton handover procedure in response to receiving the handover command. The method also includes continuing with the hard handover procedure when a hard handover response is received before a baton handover response, and then aborting the baton handover procedure. The method further includes continuing with the baton handover procedure when the baton handover response is received before the hard handover response, and then aborting the hard handover procedure.

According to another aspect of the present disclosure, an apparatus for wireless communication includes means for receiving a handover command. The apparatus also includes means for substantially simultaneously initiating both a hard handover procedure and a baton handover procedure in response to receiving the handover command. The apparatus also includes means for continuing with the hard handover procedure when a hard handover response is received before a baton handover response, and then aborting the baton handover procedure. The apparatus further includes means for continuing with the baton handover procedure when the baton handover response is received before the hard handover response, and then aborting the hard handover procedure.

According to one aspect of the present disclosure, an apparatus for wireless communication includes a memory and a processor(s) coupled to the memory. The processor(s) is configured to receive a handover command. The processor(s) is also configured to substantially simultaneously initiate both a hard handover procedure and a baton handover procedure in response to receiving the handover command. The processor(s) is also configured to continue with the hard handover procedure when a hard handover response is received before a baton handover response, and then to abort the baton handover procedure. The processor is further configured to continue with the baton handover procedure when the baton handover response is received before the hard handover response, and then to abort the hard handover procedure.

According to one aspect of the present disclosure, a computer program product for wireless communication in a wireless network includes a computer readable medium having non-transitory program code recorded thereon. The program code includes program code to receive a handover command. The program code also includes program code to substantially simultaneously initiate both a hard handover procedure and a baton handover procedure in response to receiving the handover command. The program code also includes program code to continue with the hard handover procedure when a hard handover response is received before a baton handover response, and then abort the baton handover procedure. The program code further includes program code to continue with the baton handover procedure when the baton handover response is received before the hard handover response, and then abort the hard handover procedure.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a nodeB in communication with a user equipment (UE) in a telecommunications system.

FIG. 4 illustrates network coverage areas according to aspects of the present disclosure.

FIG. 5A illustrates an example message sequence for a handover of a UE from a source cell to a target cell.

FIG. 5B illustrates an example of an improved message sequence for a handover of a UE from a source cell to a target cell according to aspects of the present disclosure.

FIG. 6 is a block diagram illustrating a wireless communication method according to aspects of the present disclosure.

FIG. 7 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

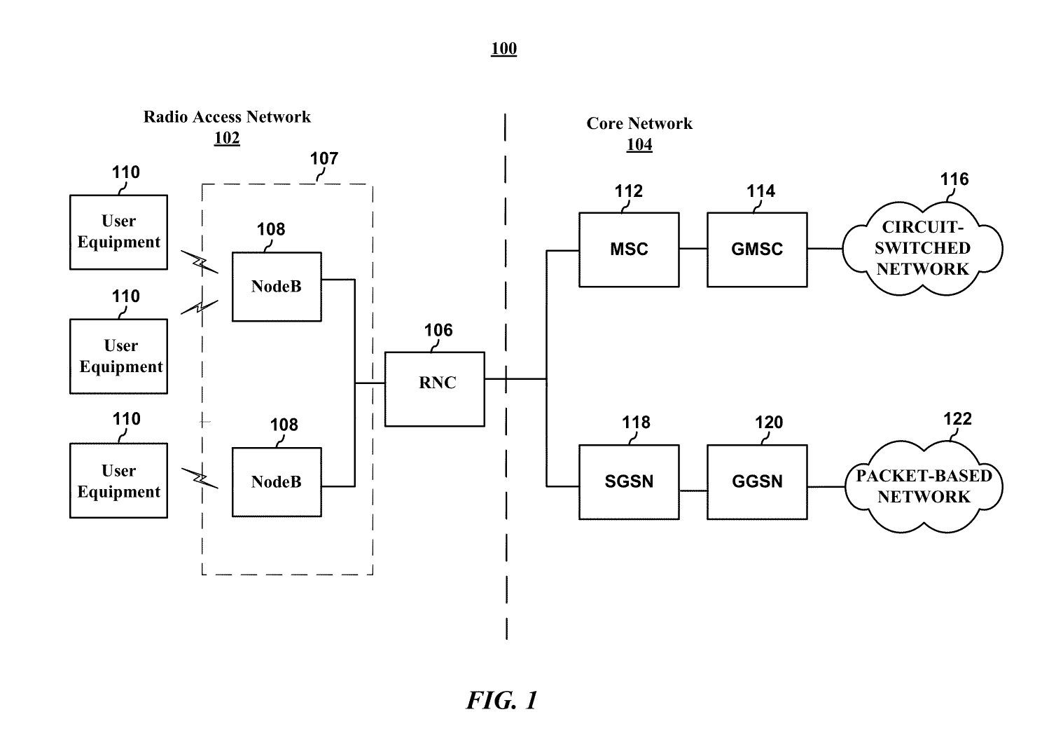

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 108 are shown; however, the RNS 107 may include any number of wireless nodeBs. The nodeBs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the nodeBs 108. The downlink (DL), also called the forward link, refers to the communication link from a nodeB to a UE, and the uplink (UL), also called the reverse link, refers to the communication link from a UE to a nodeB.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 108 and a UE 110, but divides UL and DL transmissions into different time slots in the carrier.

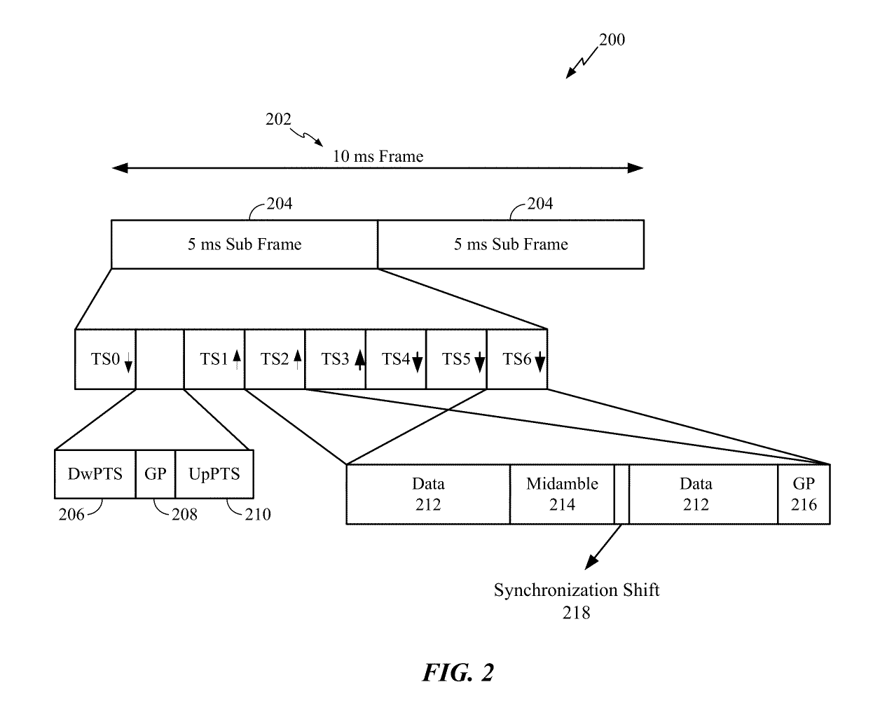

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

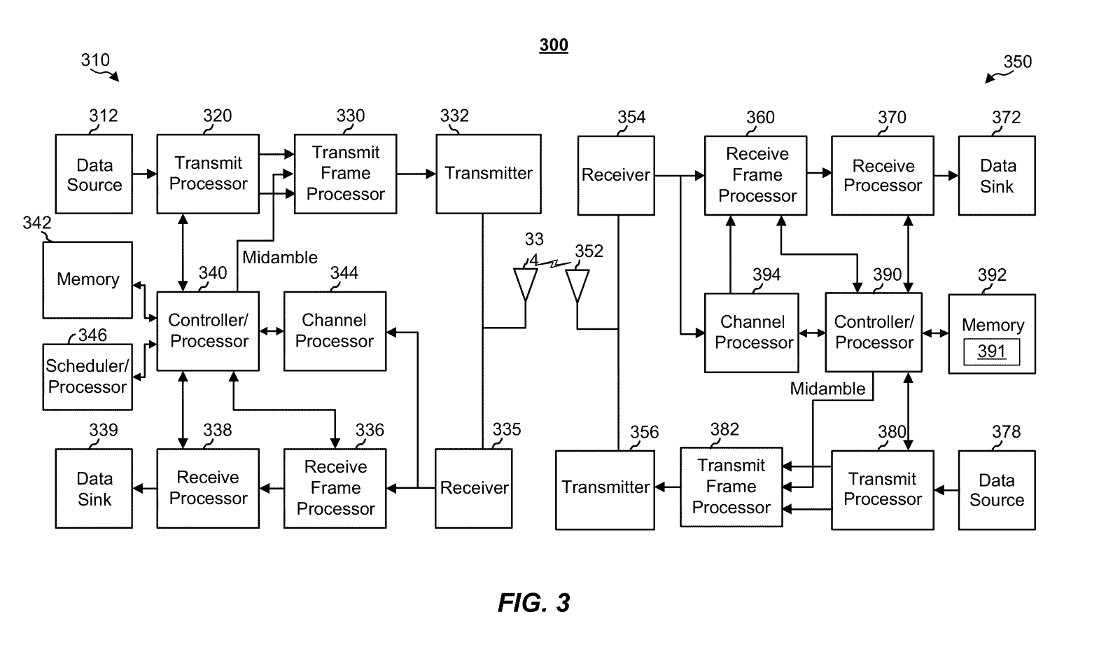

FIG. 3 is a block diagram of a nodeB 310 in communication with a UE 350 in a RAN 300, where the RAN 300 may be the RAN 102 in FIG. 1, the nodeB 310 may be the nodeB 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the nodeB 310. More specifically, the receive processor 370 descrambles and despreads the symbols, and then determines the most likely signal constellation points transmitted by the nodeB 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the nodeB 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the nodeB 310 or from feedback contained in the midamble transmitted by the nodeB 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the nodeB 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the nodeB 310 and the UE 350, respectively. For example, the controller/processors 340 and 390 may provide various functions including timing, peripheral interfaces, voltage regulation, power management, and other control functions. The computer-readable media of memories 342 and 392 may store data and software for the nodeB 310 and the UE 350, respectively. For example, the memory 392 of the UE 350 may store a handover module 391 which, when executed by the controller/processor 390, configures the UE 350 to improve inter radio access technology handover based on aspects of the present disclosure. Similarly, the memory 342 of the nodeB 310 may store a connection release modifying module 393 which, when executed by the controller/processor 340, configures the nodeB 310 to perform a radio resource control procedure based on aspects of the present disclosure. A scheduler/processor 346 at the nodeB 310 may be used to allocate resources to the UEs and schedule downlink and/or uplink transmissions for the UEs.

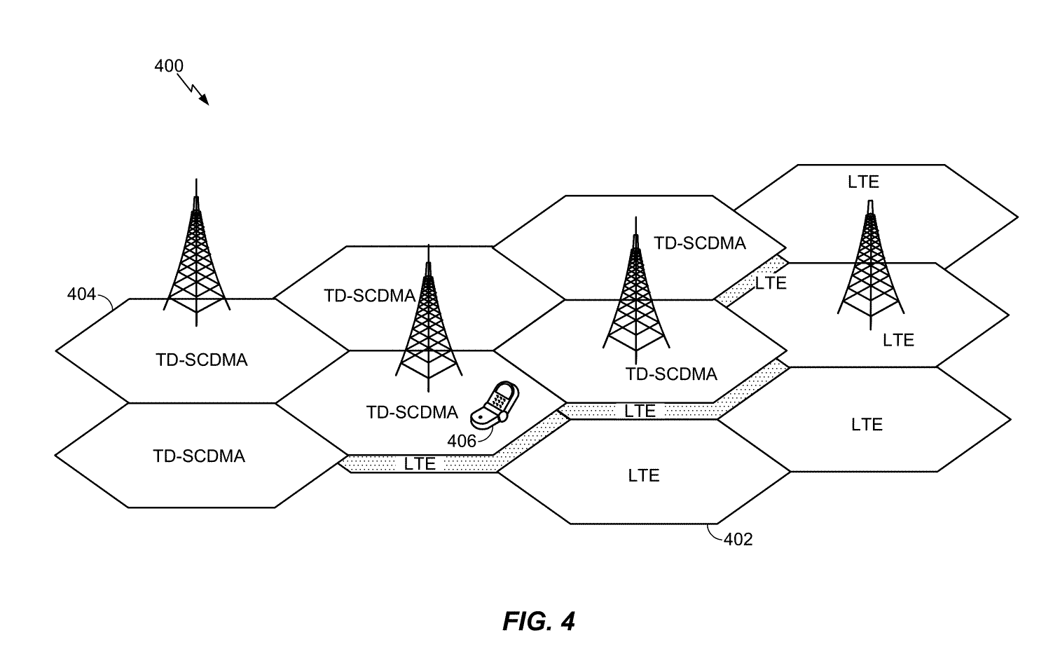

FIG. 4 illustrates coverage of a newly deployed network, such as an LTE network and also coverage of a more established network, such as a TD-SCDMA network. A geographical area 400 may include LTE cells 402 and TD-SCDMA cells 404. A user equipment (UE) 406 may move from one cell, such as a TD-SCDMA cell 404, to another cell, such as an LTE cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station ID. The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Inter Radio Access Technology Handover

Aspects of the disclosure are directed to reducing latency of handover from one radio access technology (RAT) to another RAT. The handover may be an inter radio access technology (IRAT) handover from long term evolution (LTE) to time division synchronous code division multiple access (TD-SCDMA). IRAT handover is used when a user equipment (UE) is in connected mode to enable packet switched data connection transition from a source RAT to a target RAT. Some aspects of the present disclosure combine baton and hard handover to reduce handover latency and improve throughput. Although LTE to TD-SCDMA handover is described, other types of IRAT handover are also contemplated, for example, LTE to LTE handover, and TD-SCDMA to TD-SCDMA handover.

In some communications specifications, handover is performed via random access based hard handover or baton handover. For example, LTE to TD-SCDMA handover is performed with random access information for target a TD-SCDMA cell indicated in a “handover to UTRAN command” message, such as mobilityfromEUTRAcommand. In the case of hard handover, a user equipment (UE) may switch both downlink (DL) and uplink (UL) communications from a source cell to a target cell simultaneously. In the case of baton handover, upon receiving the handover command from the source eNodeB, the UE may first switch uplink communications to the target cell, and then switch downlink communications to the target cell. These two steps of baton handover allows the target cell to acquire uplink communications, measure timing/power, and configure beamforming before the UE switches downlink communications to the target cell. As a result of the two step process, the baton handover may be less disruptive than the hard handover. However, both types of handover may require uplink synchronization during the handover process.

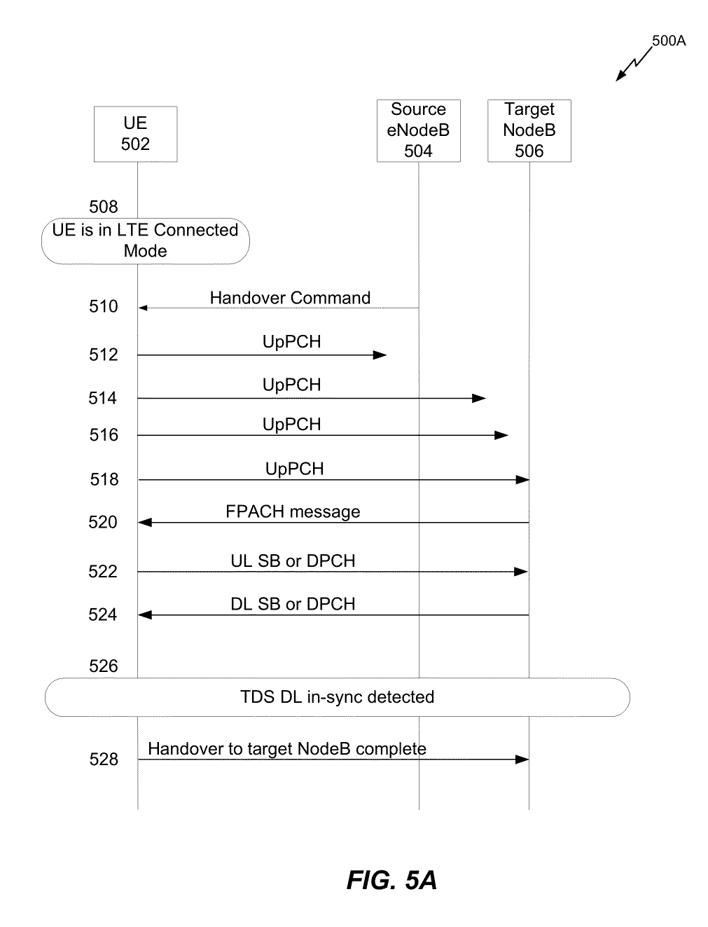

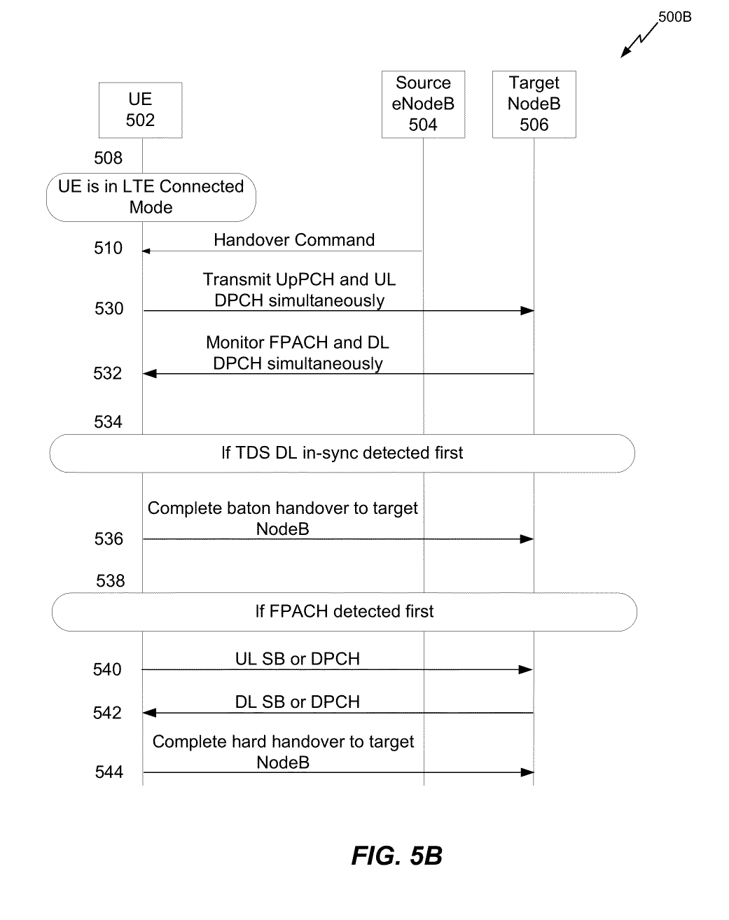

FIG. 5A illustrates an example message sequence 500A for a handover of a UE 502 from a source cell, e.g., LTE eNodeB 504 to a target cell, e.g., TD-SCDMA NodeB 506. The handover may be a random access based handover. At time 508, the UE 502 is in the idle or connected mode, such as an LTE connected mode. A radio network controller (RNC) may receive measurement report information from the UE 502. The eNodeB 504 may determine whether to handover the UE 502 from the source eNodeB 504 to the target NodeB. Based on the determination, the eNodeB 504 sends a handover command (e.g., handover to UTRAN command) to the UE 502, at time 510. The handover command causes the UE 502 to initiate the handover from the source eNodeB 504 to a target NodeB 506. For example, the UE may switch some or all communications to the target NodeB 506 when the handover command is received.

In the case of hard handover, the UE 502 switches to the target NodeB 506 and starts sending uplink synchronization sequence/codes (SYNC-UL) on an uplink pilot channel (UpPCH), at time 512. The UE 502 then waits to receive a response (e.g., acknowledgement (ACK)) on the fast physical access channel (FPACH). If the UE 502 does not receive the response over a monitored FPACH within a predetermined number of sub frames, then the UE 502 randomly chooses and transmits one of N SYNC-UL sequences with increased power over a randomly selected UpPCH. For example, if a first SYNC-UL transmitted over an UpPCH, at time 512, is not received (or erroneously received) by the target NodeB 506, the UE 502 transmits a second SYNC-UL over an UpPCH, at time 514. The second SYNC-UL may be transmitted upon expiration of a timer or when the UE 502 does not receive a response within a predetermined number of sub frames. The second SYNC-UL may be transmitted with increased power over the randomly selected UpPCH. If the second SYNC-UL is not received by the target NodeB 506, at time 516, the UE 502 transmits a third SYNC-UL with increased power over the randomly selected UpPCH. Similarly, a fourth SYNC-UL may be transmitted, at time 518, upon failure to acknowledge receipt of the third SYNC-UL. The fourth SYNC-UL may be received by the target NodeB 506, at time 518.

When the fourth SYNC-UL is detected, the target NodeB 506 transmits the ACK in the FPACH message to the UE 502, at time 520. The target NodeB 506 may also transmit uplink transmission power and timing commands (e.g., timing adjustment information) in the FPACH message to the UE 502. The timing adjustment information may be used by the UE 502 to subsequently transmit uplink dedicated physical channel (DPCH) data or a special burst (SB) on an allocated uplink channel, at time 522. The UE 502 then starts to monitor downlink DPCH or SB. The UE 502 may receive the downlink DPCH or SB from the target NodeB 506, at time 524. In some aspects, the reception of the downlink DPCH or SB indicates a good downlink reception from the target NodeB 506 and may correspond to the detection of the downlink in-sync message from the target NodeB 506. When the UE 502 detects the downlink in-sync message from the target NodeB 506, at time 526, the handover procedure is completed, at time 528. Random access based handover, however, may increase handover latency. For example, the uplink synchronization procedures for the hard and baton handovers may increase the handover latency.

To accomplish synchronization in the case of hard handover, the UE 502 may be specified to transmit the SYNC-UL, and to receive a response (FPACH message) before the normal communication (e.g., data transmission) starts. This synchronization procedure of hard handover may increase handover latency. The increase in handover latency may be due to collision of UpPCHs from different UEs, UpPCH congestion and FPACH congestion. The increase in handover latency may also be due to unavailability of FPACH to send a response to the UE 502 within a wait time when the target NodeB 506 detects a SYNC-UL. In some instances, the wait time may be up to four sub-frames. Long latency significantly reduces throughput because there is no data transmission during handover transition.

In the case of baton handover, the UE 502 switches uplink communications first to allow the target NodeB 506 to measure the uplink timing for subsequent adjustment in an end stage of the baton handover. While baton handover can reduce latency relative to hard handover, successful handover is not guaranteed due to open loop power and timing control inaccuracy associated with baton handover. For example, because of the open loop nature of timing and power of baton handover, in certain circumstances the transmit power calculated by the UE 502 is inaccurate. The inaccuracy results in uplink communications that are insufficient for the target NodeB 506 to detect the UE 502. Without the uplink communications from the UE 502, the target NodeB 506 may not be able to properly determine beamforming for downlink communications to the UE 502, and may not configure downlink transmissions to the UE 502. This failure to detect the UE 502 in turn leads to the UE 502 being unable to detect the downlink in-sync indication from the target cell within the allotted handover time indicated by the network, which results in baton handover failure.

Aspects of the present disclosure combine baton and hard handover to reduce handover latency, and to improve throughput, as illustrated in FIG. 5B.

FIG. 5B illustrates an example of an improved message sequence 500B for a handover of a UE 502 from a source eNodeB 504 to a target NodeB 506 according to aspects of the present disclosure. Similar to the message sequence of FIG. 5A, the eNodeB 504 determines whether to handover the UE 502 from the source eNodeB 504 to the target NodeB. The eNodeB 504 then sends the handover command to the UE 502, at time 510. The handover command may be a hard handover command and/or a baton handover command. The handover command causes the UE 502 to initiate the handover from the source eNodeB 504 to a target NodeB 506. For example, after receiving the handover command, the UE 502 transmits an uplink special burst (SB) or UpPCH based on an open loop procedure to the target NodeB 506, at time 530. The UE also transmits a SYNC-UL on an uplink pilot channel (UpPCH), at time 530.

Thus, the UE 502 simultaneously transmits (at time 530) the uplink special burst (SB) or UpPCH and the SYNC-UL on the UpPCH after the handover command is received. In some aspects of the present disclosure, the UE 502 monitors for a downlink in-sync indication and FPACH simultaneously, at time 532. When the UE receives or detects the downlink in-sync indication before the FPACH, at time 534, the UE 502 performs baton handover. The UE 502 also aborts the hard handover procedure when the UE detects the downlink in-sync indication before the FPACH. The UE 502 then begins closed loop power control (PC) and timing control to complete the baton handover procedure, at time 536.

When the UE 502 detects FPACH before the downlink in-sync indication, at time 538, the UE 502 performs normal random access based hard handover. In this case, the timing adjustment/power information carried on FPACH may be used by the UE 502 to transmit uplink DPCH data or a special burst on a uplink channel, at time 540. The UE 502 also aborts the baton handover procedure when the UE 502 detects FPACH before the downlink in-sync indication. The UE 502 then starts to monitor downlink DPCH or SB. The UE 502 receives the downlink DPCH or SB from the target NodeB 506, at time 542. If the downlink in-sync indication is detected, the UE 502 begins the closed loop PC and timing control to complete the hard handover procedure, at time 544.

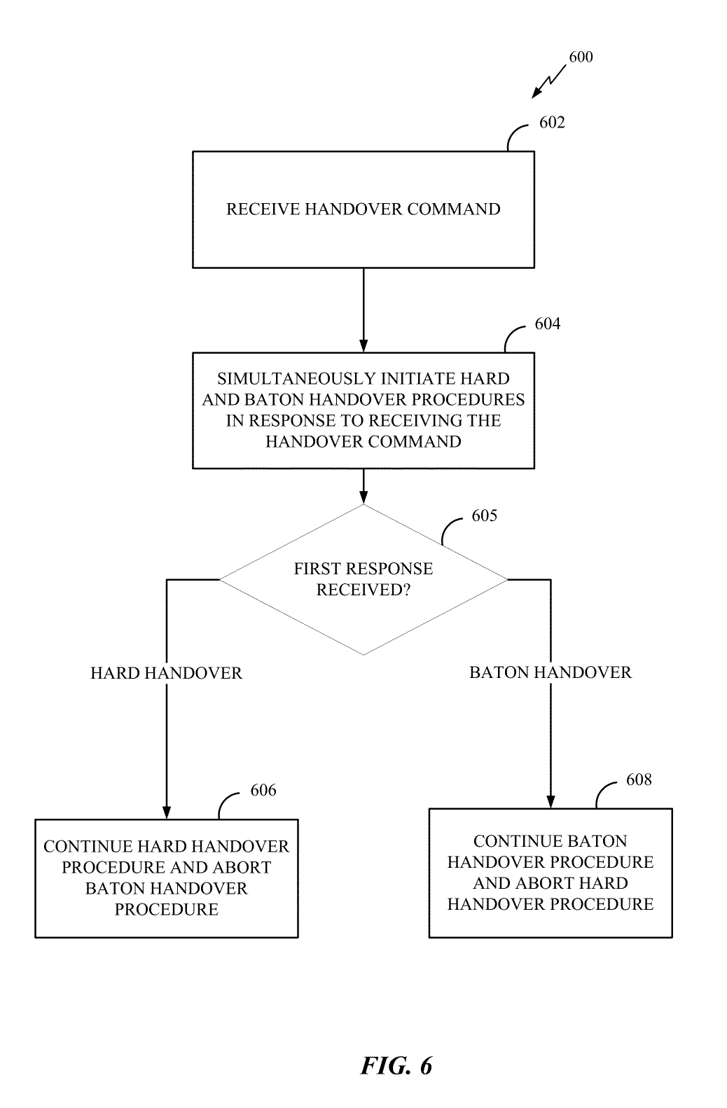

FIG. 6 is a block diagram illustrating a wireless communication method 600 for combining baton and hard handover to reduce handover latency according to aspects of the present disclosure. A UE receives a handover command, as shown in block 602. The UE initiates both a hard handover procedure and a baton handover procedure in response to receiving the handover command, as shown in block 604. The hard handover procedure may be initiated substantially simultaneously with the baton handover procedure.

At block 605 it is determined which type of response is first received. The UE continues with the hard handover procedure when a hard handover response is received before receiving a baton handover response. The UE then aborts the baton handover procedure, at block 606. Otherwise, at block 608, the UE continues with the baton handover procedure when a baton handover response is received before receiving a hard handover response and aborts the hard handover procedure.

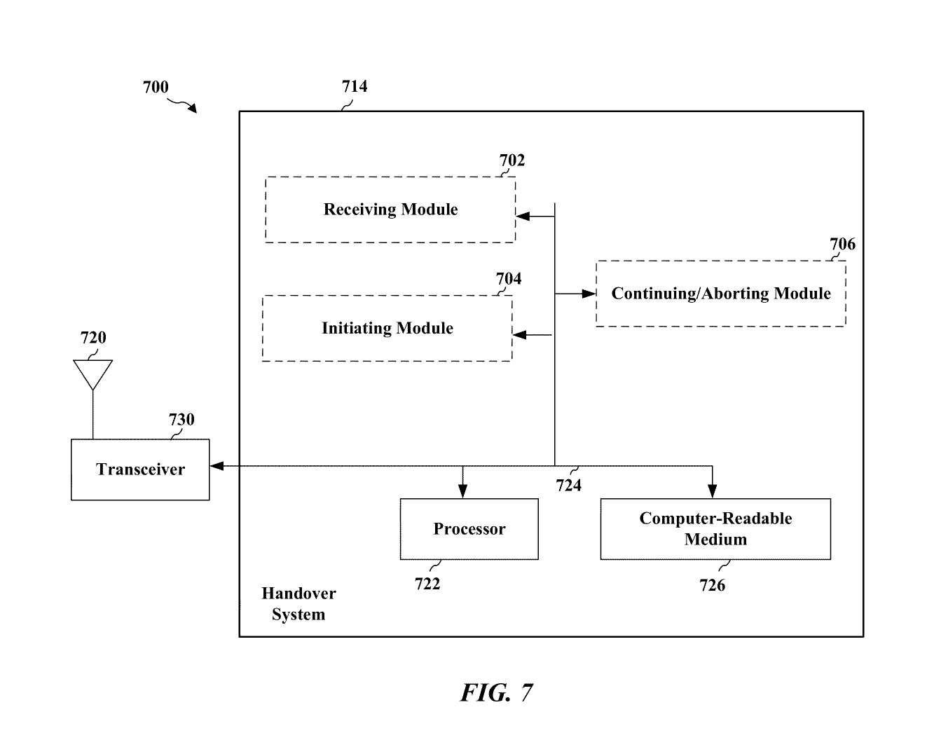

FIG. 7 is a diagram illustrating an example of a hardware implementation for an apparatus 700 employing a handover system 714. The handover system 714 may be implemented with a bus architecture, represented generally by the bus 724. The bus 724 may include any number of interconnecting buses and bridges depending on the specific application of the handover system 714 and the overall design constraints. The bus 724 links together various circuits including one or more processors and/or hardware modules, represented by the processor 722, the receiving module 702, the initiating module 704, the continuing/aborting module 706 and the computer-readable medium 726. The bus 724 may also link various other circuits such as timing sources, peripherals, voltage regulators, and power management circuits, which are well known in the art, and therefore, will not be described any further.

The apparatus includes a handover system 714 coupled to a transceiver 730. The transceiver 730 is coupled to one or more antennas 720. The transceiver 730 enables communicating with various other apparatus over a transmission medium. The handover system 714 includes a processor 722 coupled to a computer-readable medium 726. The processor 722 is responsible for general processing, including the execution of software stored on the computer-readable medium 726. The software, when executed by the processor 722, causes the handover system 714 to perform the various functions described for any particular apparatus. The computer-readable medium 726 may also be used for storing data that is manipulated by the processor 722 when executing software.

The handover system 714 includes a receiving module 702 for receiving a handover command. The handover system 714 also includes an initiating module 704 for substantially simultaneously initiating both a hard handover procedure and a baton handover procedure in response to receiving the handover command. The handover system further includes a continuing/aborting module 706 for continuing with a hard/baton handover procedure and aborting the baton/hard handover procedure. The modules may be software modules running in the processor 722, resident/stored in the computer-readable medium 726, one or more hardware modules coupled to the processor 722, or some combination thereof. The handover system 714 may be a component of the UE 350 and may include the memory 392, and/or the controller/processor 390.

In one configuration, an apparatus, such as an UE 350, is configured for wireless communication including means for receiving. In one aspect, the above means may be the antennas 352, 720, the receiver 354, the transceiver 730, the receive processor 370, the controller/processor 390, the memory 392, the handover module 391, the receiving module 702, the processor 722, and/or the handover system 714 configured to perform the functions recited by the aforementioned means. In another aspect, the aforementioned means may be a module or any apparatus configured to perform the functions recited by the aforementioned means.

In one configuration, the apparatus configured for wireless communication also includes means for initiating. In one aspect, the above means may be the antennas 352, 720, the receiver 354, the transmitter 356, the transceiver 730, the receive processor 370, the transmit processor 380, the controller/processor 390, the memory 392, the handover module 391, the initiating module 704, the processor 722, and/or the handover system 714 configured to perform the functions recited by the aforementioned means. In another aspect, the aforementioned means may be a module or any apparatus configured to perform the functions recited by the aforementioned means.

In another configuration, the apparatus configured for wireless communication includes means for continuing with the hard/baton handover and for aborting the baton/hard handover. In one aspect, the above means may be the antennas 352, 720, the receiver 354, the transmitter 356, the transceiver 730, the receive processor 370, the transmit processor 380, the controller/processor 390, the memory 392, the handover module 391, the continuing/aborting module 706, the processor 722, and/or the handover system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a handover command;
substantially simultaneously initiating both a hard handover procedure and a baton handover procedure in response to receiving the handover command;
continuing with the hard handover procedure when a hard handover response is received before a baton handover response, and then aborting the baton handover procedure; and
continuing with the baton handover procedure when the baton handover response is received before the hard handover response, and then aborting the hard handover procedure.

2. The method of claim 1, in which substantially simultaneously initiating both the hard handover procedure and the baton handover procedure comprises:
transmitting an uplink synchronization sequence on an uplink pilot channel and uplink dedicated physical channel (DPCH); and
substantially simultaneously monitoring for a downlink in-synchronization condition on a downlink DPCH and a random access response on a fast physical access channel (FPACH).

3. The method of claim 1, in which the hard handover response includes a random access response on a fast physical access channel (FPACH) and the baton handover response includes a detection of a downlink in-synchronization condition on a downlink dedicated physical channel, in which receiving the baton handover response before receiving the hard handover response comprises detecting the downlink in-synchronization condition on the downlink dedicated physical channel before receiving the random access response on the FPACH.

4. The method of claim 1, in which receiving the hard handover response before receiving the baton handover response comprises receiving a random access response on a fast physical access channel (FPACH) before detecting a downlink in-synchronization condition on a downlink dedicated physical channel.

5. The method of claim 1, in which continuing baton handover and aborting hard handover further comprises:
transmitting on an uplink dedicated physical channel (DPCH) in accordance with a closed loop power control command carried on a downlink DPCH and a closed loop timing control command carried on the downlink DPCH; and
stopping sending of an uplink synchronization sequence on an uplink pilot channel and stopping monitoring of a fast physical access channel (FPACH).

6. The method of claim 1, in which continuing hard handover and aborting baton handover comprises:
transmitting on an uplink dedicated physical channel (DPCH) based on an uplink transmission time and power carried in a random access response on a fast physical access channel (FPACH); and
stopping sending on an uplink DPCH with fixed timing and power for baton handover.

7. An apparatus for wireless communication, comprising:
means for receiving a handover command;
means for substantially simultaneously initiating both a hard handover procedure and a baton handover procedure in response to receiving the handover command;
means for continuing with the hard handover procedure when a hard handover response is received before a baton handover response, and then aborting the baton handover procedure; and
means for continuing with the baton handover procedure when the baton handover response is received before the hard handover response, and then aborting the hard handover procedure.

8. The apparatus of claim 7, in which the initiating means further comprises:
means for transmitting an uplink synchronization sequence on an uplink pilot channel and an uplink dedicated physical channel (DPCH); and
means for substantially simultaneously monitoring for a downlink in-synchronization condition on a downlink DPCH and a random access response on a fast physical access channel (FPACH).

9. The apparatus of claim 7, in which the hard handover response includes a random access response on a fast physical access channel (FPACH) and the baton handover response includes a detection of a downlink in-synchronization condition on a downlink dedicated physical channel, in which the means for continuing with the baton handover procedure further comprises means for continuing with the baton handover procedure when the downlink in-synchronization condition on the downlink dedicated physical channel is detected before receiving the random access response on the FPACH.

10. The apparatus of claim 7, in which the means for continuing with the hard handover procedure further comprises means for continuing with the hard handover procedure when a response on a fast physical access channel (FPACH) is received before detecting a downlink in-synchronization condition on a downlink dedicated physical channel.

11. An apparatus for wireless communication, comprising:
a memory; and
at least one processor coupled to the memory and configured:
to receive a handover command;
to substantially simultaneously initiate both a hard handover procedure and a baton handover procedure in response to receiving the handover command;
to continue with the hard handover procedure when a hard handover response is received before a baton handover response, and then to abort the baton handover procedure; and
to continue with the baton handover procedure when the baton handover response is received before the hard handover response, and then to abort the hard handover procedure.

12. The apparatus of claim 11, in which the at least one processor is further configured to substantially simultaneously initiate both the hard handover procedure and the baton handover procedure by:
transmitting an uplink synchronization sequence on an uplink pilot channel and uplink dedicated physical channel (DPCH); and
substantially simultaneously monitoring for a downlink in-synchronization condition on a downlink DPCH and a random access response on a fast physical access channel (FPACH).

13. The apparatus of claim 11, in which the hard handover response includes a random access response on a fast physical access channel (FPACH) and the baton handover response includes a detection of a downlink in-synchronization condition on a downlink dedicated physical channel, in which the at least one processor is further configured to continue with the baton handover procedure when the downlink in-synchronization condition on the downlink dedicated physical channel is detected before receiving the random access response on the FPACH.

14. The apparatus of claim 11, in which the at least one processor is further configured to continue with the hard handover procedure when a response on a fast physical access channel (FPACH) is received before detecting a downlink in-synchronization condition on a downlink dedicated physical channel.

15. The apparatus of claim 11, in which the at least one processor is further configured to continue baton handover and to abort hard handover by:
transmitting on an uplink dedicated physical channel (DPCH) in accordance with a closed loop power control command carried on a downlink DPCH and a closed loop timing control command carried on the downlink DPCH; and
stopping sending of an uplink synchronization sequence on an uplink pilot channel and stopping monitoring of a fast physical access channel (FPACH).

16. The apparatus of claim 11, in which the at least one processor is further configured to continue hard handover and to abort baton handover by:
transmitting on an uplink dedicated physical channel (DPCH) based on an uplink transmission time and power carried in a random access response on a fast physical access channel (FPACH); and
stopping sending on an uplink DPCH with fixed timing and power for baton handover.

17. A computer program product for wireless communication in a wireless network, comprising:
a non-transitory computer-readable medium having program code recorded thereon, the program code comprising:
program code to receive a handover command;
program code to substantially simultaneously initiate both a hard handover procedure and a baton handover procedure in response to receiving the handover command;
program code to continue with the hard handover procedure when a hard handover response is received before a baton handover response, and then abort the baton handover procedure; and
program code to continue with the baton handover procedure when the baton handover response is received before the hard handover response, and then abort the hard handover procedure.

18. The computer program product of claim 17, in which the program code to substantially simultaneously initiate further comprises:
program code to transmit an uplink synchronization sequence on an uplink pilot channel and uplink dedicated physical channel (DPCH); and
program code to substantially simultaneously monitor for a downlink in-synchronization condition on a downlink DPCH and a random access response on a fast physical access channel (FPACH).

19. The computer program product of claim 17, in which the hard handover response includes a random access response on a fast physical access channel (FPACH) and the baton handover response includes a detection of a downlink in-synchronization condition on a downlink dedicated physical channel, in which the program code to continue with the baton handover procedure further comprises program code to continue with the baton handover procedure when the downlink in-synchronization condition on the downlink dedicated physical channel is detected before receiving the random access response on the FPACH.

20. The computer program product of claim 17, in which the program code to continue with the hard handover procedure further comprises program code to continue with the hard handover procedure when a random access response on a fast physical access channel (FPACH) is received before detecting a downlink in-synchronization condition on a downlink dedicated physical channel.
